(19) United States
(12) Patent Application Publication
(10) Pub. No.: US 2026/0024460 A1
(43) Pub. Date: Jan. 22, 2026

(54) TEACHING DEVICE, TEACHING METHOD, AND NON-TRANSITORY COMPUTER-READABLE STORAGE MEDIUM STORING TEACHING PROCESSING PROGRAM

(71) Applicant: Yamaha Corporation, Hamamatsu (JP)

(72) Inventors: Satoshi OBATA, Hamamatsu (JP); Misa UEHARA, Tokyo (JP); Akira MAEZAWA, Yokohama-shi (JP); Yuki MORIJIRI, Tokyo (JP)

(21) Appl. No.: 19/341,617

(22) Filed: Sep. 26, 2025

Related U.S. Application Data
(63) Continuation of application No. PCT/JP2024/008062, filed on Mar. 4, 2024.

(30) Foreign Application Priority Data
Mar. 27, 2023 (JP) 2023-050505

(51) Int. Cl. G09B 15/00; G09B 5/02; G10H 1/00

(52) U.S. Cl. CPC G09B 15/00; G09B 5/02; G10H 1/0008; G10H 2210/091

(57) ABSTRACT

A teaching device includes a controller including memory storing instructions and at least one processor that implements the instructions. The instructions include acquiring reference data indicating a time series of reference sounds. The instructions include acquiring performance data indicating a time series of sounds expressed by a user's performance. The instructions include detecting a performance error by comparing the reference data and the performance data. The instructions include estimating a cause of the error based on performance history. The instructions include determining an instruction content item based on frequency of the error and the cause.

### CROSS-REFERENCE TO RELATED APPLICATIONS

This application is a continuation application of International Application No. PCT/JP2024/008062, filed on Mar. 4, 2024, which claims priority to Japanese Patent Application No. 2023-050505 filed in Japan on Mar. 27, 2023. The entire disclosures of International Application No. PCT/JP2024/008062 and Japanese Patent Application No. 2023-050505 are hereby incorporated herein by reference.

### BACKGROUND

### Technical Field

The present invention generally relates to a teaching device, a teaching method, and a teaching program for teaching performance.

### Background Information

Teaching devices for teaching a user how to play a musical instrument are known (for example, Japanese Patent No. 3371791 (hereinafter referred to as Patent Document 1), Japanese Patent No. 3582315 (hereinafter referred to as Patent Document 2), Japanese Patent No. 3582320 (hereinafter referred to as Patent Document 3), Japanese Patent No. 3582427 (hereinafter referred to as Patent Document 4), Japanese Patent No. 3624773 (hereinafter referred to as Patent Document 5), Japanese Patent No. 3767612 (hereinafter referred to as Patent Document 6), Japanese Patent No. 3842403 (hereinafter referred to as Patent Document 7)). For example, Patent Document 1 discloses a music teaching system that includes a student terminal and a teacher terminal that are connected via a network. The student practices playing in accordance with a curriculum on the student terminal, and performance data indicating the results of the practice are transmitted to the teacher terminal.

An individual advice file for each student is created on the teacher terminal on the basis of the curriculum and personal information data transmitted simultaneously with the performance data. The created advice file is transmitted to the student terminal. When the advice file is opened on the student terminal, comments, etc., contained in the advice file are displayed on a display unit of the student terminal. As a result, the student is encouraged to improve even if there was an error in the performance.

When playing a musical instrument, errors occur due to various causes. Therefore, even if the same performance error occurs, the cause is not necessarily the same. However, in the systems of Patent Documents 1-7 described above, the same evaluation result, such as the same comment, is presented for the same performance error. Therefore, providing practical teaching of performance is difficult.

An object of the present disclosure is to provide a teaching device, a teaching method, and a teaching program that can provide practical teaching of performance.

### SUMMARY

A teaching device according to one aspect of the present disclosure comprises a controller including memory storing instructions and at least one processor that implements the instructions, the instructions comprising acquiring reference data indicating a time series of reference sounds, acquiring performance data indicating a time series of sounds expressed by a user's performance, detecting a performance error by comparing the reference data and the performance data, estimating a cause of the error based on performance history, and determining an instruction content item based on frequency of the error and the cause.

A teaching method according to another aspect of the present disclosure is executed by a computer, the method comprising acquiring reference data indicating a time series of reference sounds, acquiring performance data indicating a time series of sounds expressed by a user's performance, detecting a performance error by comparing the reference data and the performance data, estimating a cause of the error on the basis of performance history, and determining an instruction content item on the basis of frequency of the error and the cause.

A teaching program according to yet another aspect of the present disclosure is a program that causes a computer to execute a teaching method, causing the computer to execute a process for acquiring reference data indicating a time series of reference sounds, a process for acquiring performance data indicating a time series of sounds expressed by a user's performance, a process for detecting a performance error by comparing the reference data and the performance data, a process for estimating a cause of the error on the basis of performance history, and a process for determining an instruction content item on the basis of frequency of the error and the cause.

### BRIEF DESCRIPTION OF THE DRAWINGS

FIG. 1 is a block diagram showing a configuration of a teaching system including a teaching device according to one embodiment of the present disclosure.

FIG. 2 is a block diagram showing a configuration of the teaching device.

FIG. 3 is a table showing an example of performance errors as classified by a detection unit.

FIG. 4 is a table showing an example of performance errors as classified by the detection unit.

FIG. 5 is a table showing details of codes assigned to the causes of errors in the figure.

FIG. 6 is a table showing details of numbers assigned to instruction content items of FIG. 4.

FIG. 7 is a diagram showing one example of instruction content items displayed on a display unit.

FIG. 8 is a flowchart showing one example of a teaching process of the teaching device of FIG. 2.

FIG. 9 is a block diagram showing a configuration of a teaching device according to a first modified example.

FIG. 10 is a block diagram showing a configuration of a teaching device according to a second modified example.

FIG. 11 is a block diagram showing a configuration of a teaching device according to a third modified example.

### DETAILED DESCRIPTION OF THE EMBODIMENTS

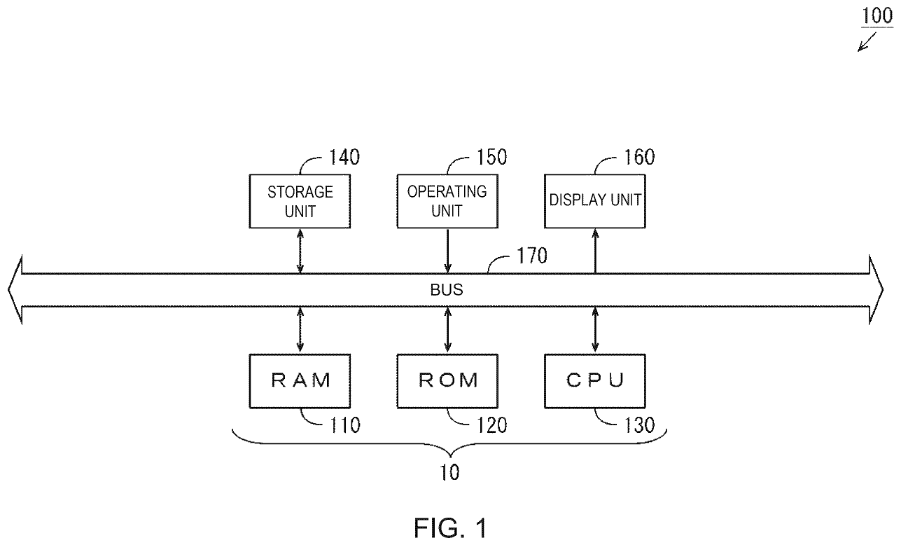

A teaching device according to the embodiment of the present disclosure will be described in detail below, with reference to the drawings. FIG. 1 is a block diagram showing a configuration of a teaching system including the teaching device according to one embodiment of the present disclosure. As shown in FIG. 1, a teaching system 100 includes RAM (random access memory) 110, ROM (read only memory) 120, a CPU (central processing unit) 130, a storage unit 140, an operating unit 150, and a display unit 160.

The teaching system 100 is realized by a computer, such as a personal computer, a tablet terminal, or a smartphone. Alternatively, the teaching system 100 can be realized by an electronic instrument equipped with a performance function, such as an electronic piano.

The teaching system 100 can be realized by means of co-operative operation of a plurality of computers connected by a communication channel, such as Ethernet.

The RAM 110, the ROM 120, the CPU 130, the storage unit 140, the operating unit 150, and the display unit 160 are connected to a bus 170. The RAM 110, the ROM 120, and the CPU 130 constitute a teaching device 10. The RAM 110 consists of volatile memory, for example, and is used as a work area for the CPU 130. The ROM 120 consists of non-volatile memory, for example, and stores a teaching program. The CPU 130 executes, on the RAM 110, the teaching program stored in the ROM 120 in order to perform a teaching process. Details of the teaching process will be mentioned below.

The teaching program can be stored in the storage unit 140 instead of the ROM 120. Alternatively, the teaching program can be provided in a form stored on a computer-readable storage medium and installed in the ROM 120 or the storage unit 140. Alternatively, if the teaching system 100 is connected to a network, such as the Internet, a teaching program distributed from a server (including a cloud server) on the network can be installed in the ROM 120 or the storage unit 140.

The storage unit 140 includes a storage medium such as a hard disk, an optical disk, a magnetic disk, or a memory card. The storage unit 140 stores, in advance, correspondence information and instruction information. Correspondence information indicates the correspondence relationship of performance errors, the frequency thereof, and the causes of the errors, in a practice piece played by the user. The instruction information indicates instruction content items for resolving each of the performance errors in the correspondence information. The correspondence information and the instruction information can be stored in advance in the ROM 120, for example. In addition, the correspondence information and the instruction information can be in a table format.

A performance of a practice piece in the present example means fully performing the entire practice piece indicated by reference data, described further below. The musical instrument used for playing the practice piece is not particularly limited, and can be a keyboard instrument, a string instrument, or a percussion instrument. In addition to periodically fully performing a practice piece, a user will usually also intensively practice playing only a section of the practice piece, such as a section where errors are frequently made. Accordingly, each time the user fully performs the practice piece, the performance technique of the user improves and the causes and frequency of errors will change.

The operating unit 150 includes a keyboard or a pointing device such as a mouse and is operated by the user to make various designations or settings in the teaching process. The display unit 160 includes a liquid crystal display, for example, and displays the instruction content item, etc., presented by the teaching process. The operating unit 150 and the display unit 160 can be configured as a touch panel display.

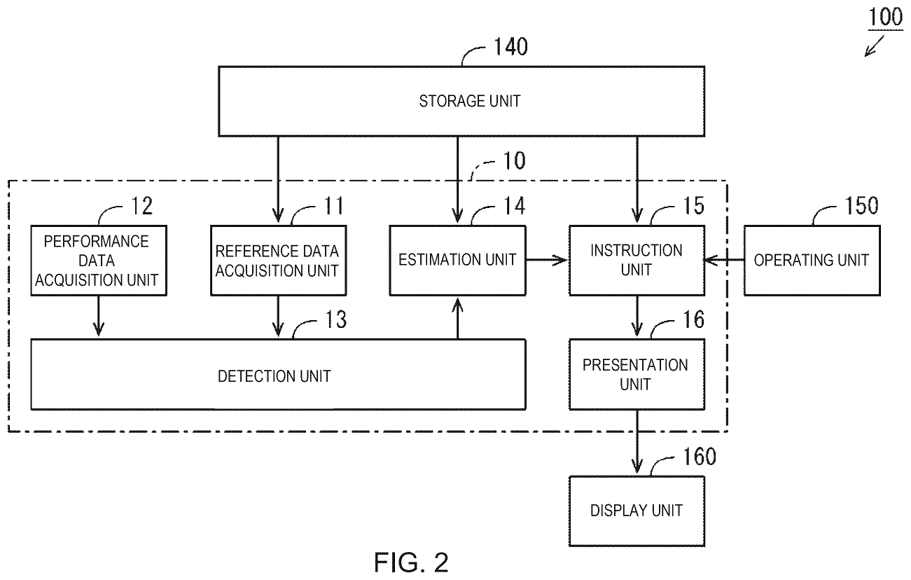

FIG. 2 is a block diagram showing a configuration of the teaching device 10. As shown in FIG. 2, the teaching device 10 includes, as functional units, a reference data acquisition unit 11, a performance data acquisition unit 12, a detection unit 13, an estimation unit 14, an instruction unit 15, and a presentation unit 16. The functional units of the teaching device 10 are realized by the CPU 130 of FIG. 1 executing the teaching program on the RAM 110. At least a part of the functional units of the teaching device 10 can be realized in hardware, such as an electronic circuit.

The reference data acquisition unit 11 acquires reference data indicating a time series of reference sounds of a practice piece played by the user. The reference data can be musical score data indicating the musical score of the practice piece. In the present embodiment, the reference data acquisition unit 11 acquires, as the reference data, specified musical score data from among a plurality of pieces of musical score data stored in the storage unit 140. The user can operate the operating unit 150 to specify the desired musical score data.

The performance data acquisition unit 12 acquires performance data indicating a time series of sounds in a practice piece each time the user plays the practice piece. In the present embodiment, the performance data are MIDI (Musical Instrument Digital Interface) data played by the user, but the embodiment is not limited thereto. The performance data need only be data that indicate a time series of sounds expressed by a user's performance. Accordingly, the performance data can be an audio signal of the practice piece played by the user. Alternatively, the performance data can be a fingering sequence or posture of the user obtained from a camera input.

The detection unit 13 compares the reference data acquired by the reference data acquisition unit 11 with the performance data acquired by the performance data acquisition unit 12 to detect performance errors at each time point on a time axis in the practice piece. In addition, some errors, such as when the same sound is repeatedly produced, can be detected without relying on the reference data. The detection unit 13 classifies the detected errors into a plurality of types in accordance with the origin of the error, such as incorrect understanding of the musical score or the lack of motor performance. The classification of errors is updated each time performance data of the same performance piece are acquired by the performance data acquisition unit 12.

The estimation unit 14 estimates the cause of the error on the basis of performance history of the user. Specifically, the cause of the error is estimated on the basis of the classified error type and the frequency thereof, and correspondence information stored in the storage unit 140. The frequency of errors includes the frequency of the same type of error occurring in one performance as well as the frequency of the same type of error occurring over a plurality of performances. The estimated cause of the error is updated each time performance data of the same performance piece are acquired by the performance data acquisition unit 12.

The instruction unit 15 determines an instruction content item for resolving the error on the basis of the frequency of the error, the cause of the error estimated by the estimation unit 14, and instruction information stored in the storage unit 140. The instruction unit 15 can determine the instruction content item each time the performance data acquisition unit 12 acquires performance data. On the other hand, the user can operate the operating unit 150 to set, to the instruction unit 15, the frequency with which to determine the instruction content item (for example, the number of performances) in accordance with the degree of improvement in the user's performance technique. When the number of times is set, the instruction unit 15 determines the instruction content item each time the performance data acquisition unit 12 acquires performance data for the set number of times.

The presentation unit 16 displays the instruction content item determined by the instruction unit 15 on the display unit 160 to present the instruction content item to the user.

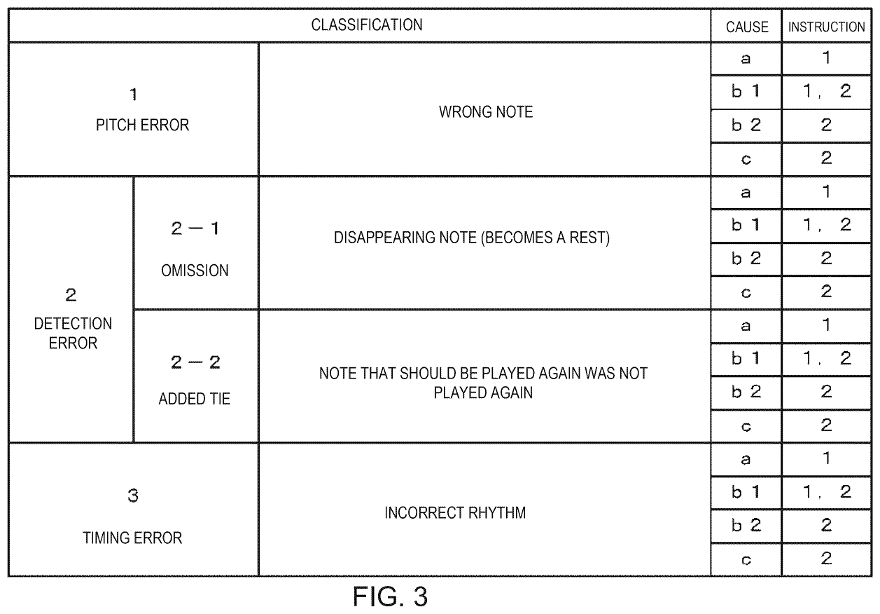

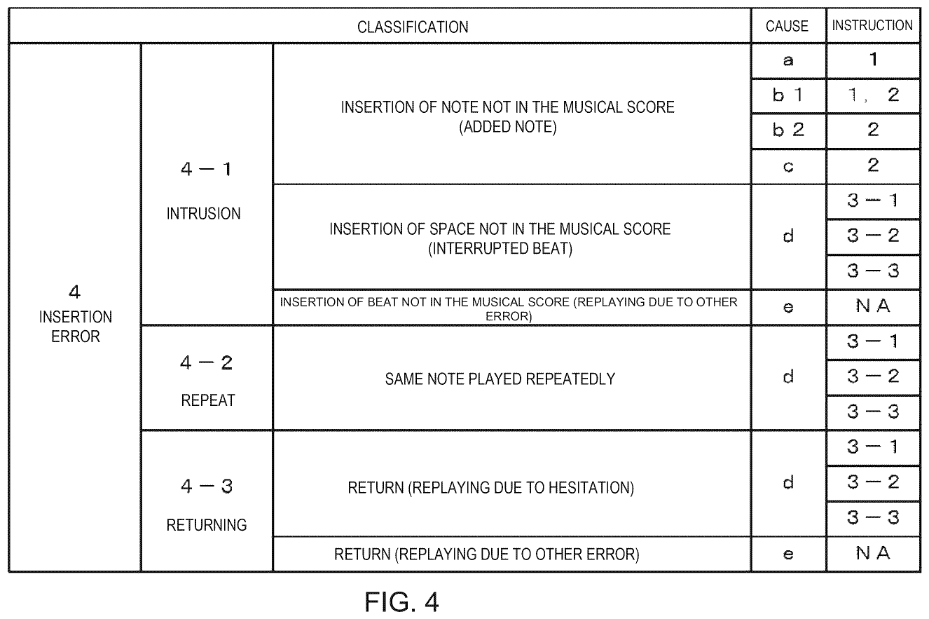

FIGS. 3 and 4 are tables showing an example of performance errors as classified by the detection unit 13. As shown in FIGS. 3 and 4, performance errors are classified into “class 1” to “class 4.” “Class 1,” “class 2,” and “class 3” respectively derive from pitch errors, sound detection errors, and timing errors in a performance. “Class 4” derives from note insertion error in a performance. In addition, “class 2” is subdivided into “class 2-1” and “class 2-2,” and “class 4” is subdivided into “class 4-1” to “class 4-4.” Errors classified as “class 1” to “class 3” as well as some of “class 4” are detected on the basis of reference data (for example, musical score data) that indicate a time series of reference sounds.

In the tables of FIGS. 3 and 4, codes assigned to the classified causes of errors are listed so as to correspond to said errors. The cause of an error is estimated by the estimation unit 14 on the basis of the classified error type and the frequency thereof, and correspondence information. The tables of FIGS. 3 and 4 also list numbers assigned to the instruction content items corresponding to the causes of errors. The instruction content item is determined by the instruction unit 15 on the basis of the frequency of the error and the cause estimated by the estimation unit 14.

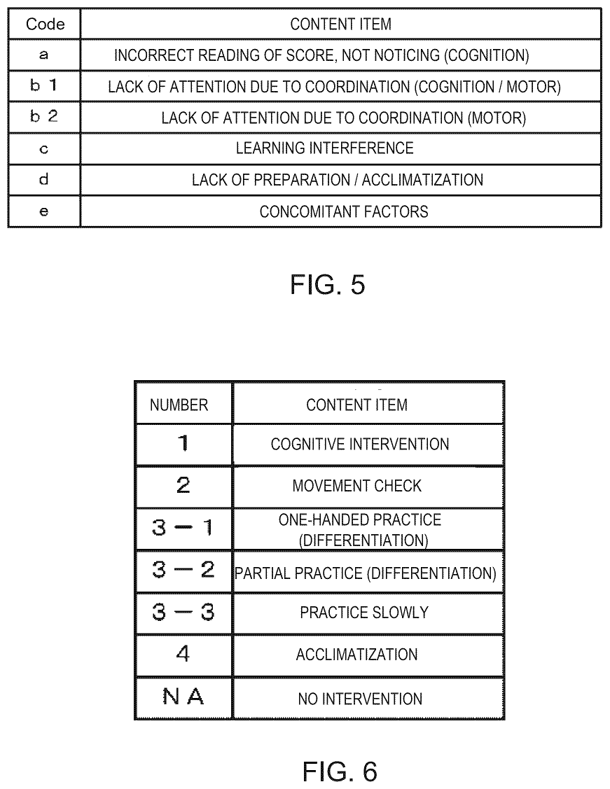

FIG. 5 is a table showing the details of the codes assigned to the causes of errors in FIG. 4. As shown in FIG. 5, in the present embodiment, “code a,” “code b1,” “code b2,” “code c,” “code d,” and “code e” are assigned to a plurality of causes of errors in accordance with the content of the cause of the error. FIG. 6 is a table showing the details of the numbers assigned to the instruction content items of FIG. 4. As shown in FIG. 6, in the present embodiment, “number 1,” “number 2,” “number 3-1,” “number 3-2,” “number 3-3,” “number 4,” and “code NA” are assigned to a plurality of instruction content items.

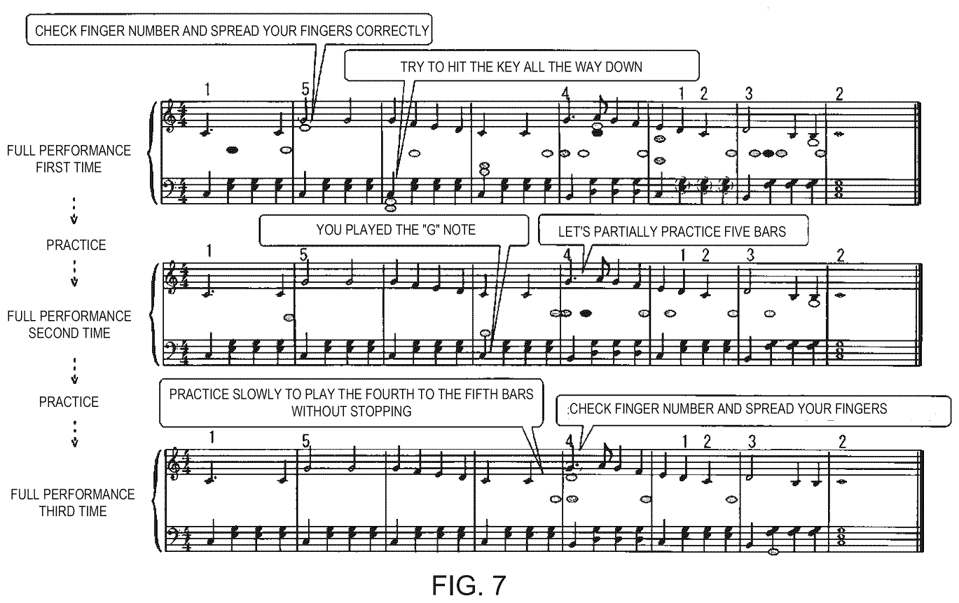

The instruction content item determined by the instruction unit 15 is displayed on the display unit 160 by the presentation unit 16. FIG. 7 is a diagram showing one example of instruction content items displayed on the display unit 160. The upper, middle, and lower rows of FIG. 7 respectively show instruction content items for the first, second, and third performances (full performances). The first, second, and third performances refer to the time series of sounds in the practice piece indicated by the performance data acquired the first, the second, and third times, respectively, by the performance data acquisition unit 12.

In the example of FIG. 7, the instruction content items determined by the instruction unit 15 are shown in balloons pointing to the portions of the musical score of the practice piece where errors occurred. The user practices the practice piece as appropriate and as needed during periods between performances. Therefore, as the number of performances increases, the user's performance technique improves, changing the causes and frequency of errors. Accordingly, as the number of performances increases, even if the same error occurs, the instruction content item that is presented changes. In general, as the number of performances increases, instruction content items that encourage more advanced movements are presented.

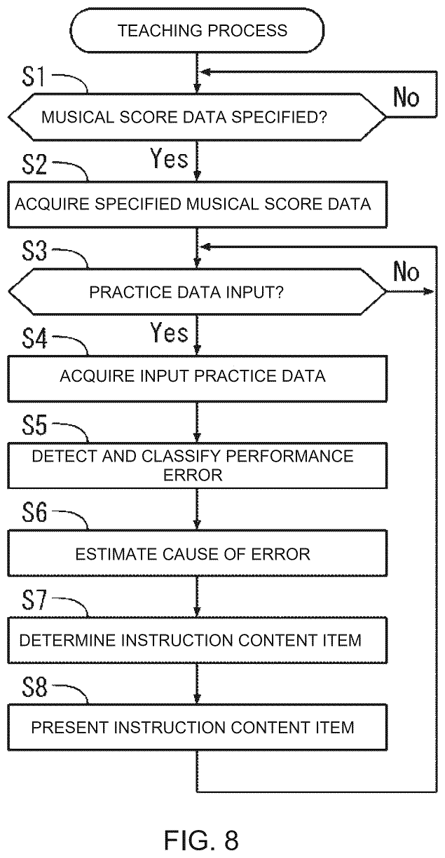

FIG. 8 is a flowchart showing one example of a teaching process of the teaching device 10 of FIG. 2. The teaching process of FIG. 8 is carried out by the CPU 130 of FIG. 1 executing a teaching program on the RAM 110. One example of a teaching process according to the present embodiment will be described below using the flowchart of FIG. 8 and the teaching device 10 of FIG. 2.

First, the reference data acquisition unit 11 determines whether musical score data have been specified (step S1). The user can operate the operating unit 150 to specify the musical score data of the practice piece to practice from among the musical score data stored in the storage unit 140. If musical score data are not specified, the reference data acquisition unit 11 waits until musical score data are specified. If the musical score data are specified, the reference data acquisition unit 11 acquires the specified musical score data from the storage unit 140 (step S2).

Next, the performance data acquisition unit 12 determines whether practice data have been input (step S3). The user can use a prescribed equipment and play the practice piece to generate the performance data and input the performance data to the teaching device 10. If practice data are not input, the performance data acquisition unit 12 waits until practice data are input. If the practice data are input, the performance data acquisition unit 12 acquires the practice data that have been input (step S4).

Subsequently, the detection unit 13 detects performance errors in the practice piece on the basis of the musical score data acquired in step S2 and the performance data acquired in step S4, and classifies the detected errors (step S5). Thereafter, the estimation unit 14 estimates the causes of the errors on the basis of the frequency and the types of errors classified in step S5, and the correspondence information stored in the storage unit 140, etc. (step S6).

Next, the instruction unit 15 determines the instruction content items for resolving the errors on the basis of the frequency of the errors, the causes of the errors estimated in step S6, and the instruction information stored in the storage unit 140, etc. (step S7). Subsequently, the presentation unit 16 displays the instruction content item determined in step S7 on the display unit 160 to present the instruction content item to the user (step S8), and the process returns to step S3.

Each time the user plays a practice piece and practice data are input to the teaching device 10, steps S3 to S8 are repeated. As a result, the classification of errors is updated in step S5 on the basis of the newly acquired practice data. In addition, the estimated causes of the errors are updated in step S6. As a result, an instruction content item that corresponds to the degree of improvement of the user's performance technique is presented in step S8.

In the example shown in FIG. 8, each time the user plays a practice piece and the practice data are input to the teaching device 10, the instruction content item is determined in step S7 and the instruction content item is presented in step S8, but the embodiment is not limited thereto. For example, if the number of performances is set as the frequency at which the instruction content item is determined, the instruction content item can be determined in step S7 and the instruction content item can be presented in step S8 each time the performance data for the set number of times are input to the teaching device 10.

As described above, the teaching device 10 according to the present embodiment comprises the reference data acquisition unit 11 for acquiring reference data indicating a time series of reference sounds, the performance data acquisition unit 12 for acquiring performance data indicating a time series of sounds expressed by a user's performance, the detection unit 13 for detecting a performance error by comparing the reference data and the performance data, the estimation unit 14 for estimating a cause of the error on the basis of performance history, and the instruction unit 15 for determining an instruction content item on the basis of frequency and the cause of the error.

According to this configuration, even if the same error occurs in a performance, it is possible to determine the instruction content item corresponding to various causes of errors that change with the performance skill level. As a result, it is possible to provide practical teaching of performance.

The teaching device 10 can further comprise the presentation unit 16 that presents an instruction content item determined by the instruction unit 15. In this case, the user can easily understand the instruction content item with respect to the user's performance.

The estimation unit 14 can estimate the cause of an error on the basis of a table in which the frequency and the types of errors are associated with causes. In this case, the cause of an error can be easily estimated.

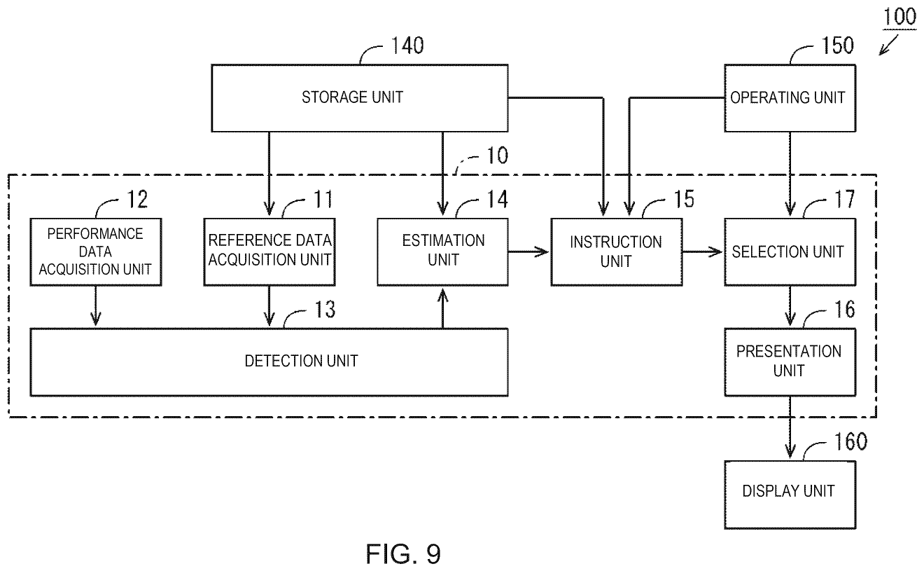

FIG. 9 is a block diagram showing a configuration of the teaching device 10 according to a first modified example. As shown in FIG. 9, the teaching device 10 according to the present example further comprises a selection unit 17 as a functional unit. The selection unit 17 can be realized by the CPU 130 of FIG. 1 executing a teaching program on the RAM 110, or realized in hardware such as an electronic circuit.

The selection unit 17 selects, from the instruction content items determined by the instruction unit 15, the instruction content item to be presented to the user with priority on the basis of the frequency or the importance of the error. In addition, the user can operate the operating unit 150 to set, to the selection unit 17, the number of instruction content items to be selected. When the number of items is set, the selection unit 17 selects the set number of instruction content items. The presentation unit 16 displays the instruction content item selected by the selection unit 17 on the display unit 160 to present the instruction content item to the user.

Therefore, in the teaching process of the present example, a process is added after step S7, the process being selecting, from the instruction content items determined by the selection unit 17 in step S7, the instruction content item to be presented to the user with priority on the basis of the frequency or the importance of the error. In addition, in step S8, the instruction content item selected by the selection unit 17 is displayed on the display unit 160 to present the instruction content item to the user.

In this manner, in the teaching device 10 according to the present example, even if a large number of instruction content items are determined by the instruction unit 15, the instruction content item to be presented with priority is selected by the selection unit 17 on the basis of the frequency or the importance of the error. As a result, it is possible to teach how to perform without excessively increasing the user burden.

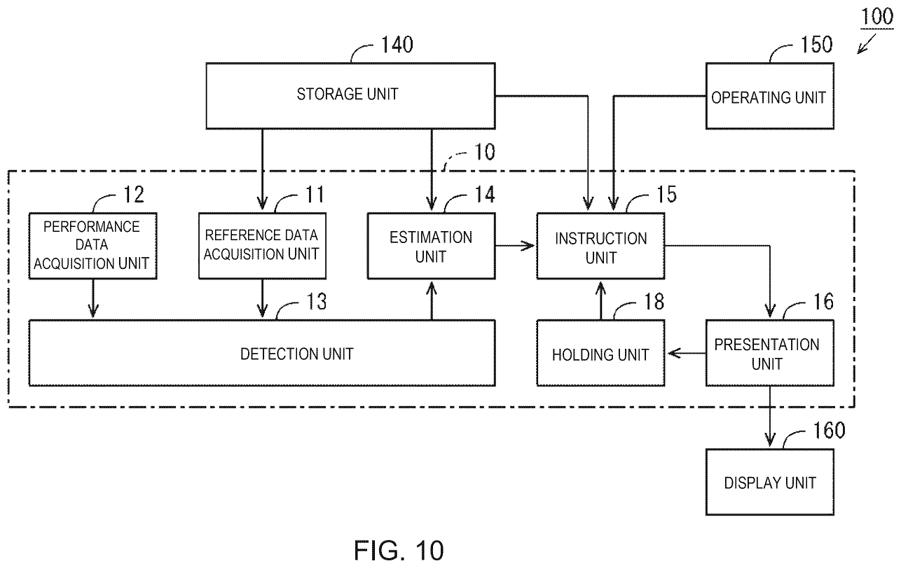

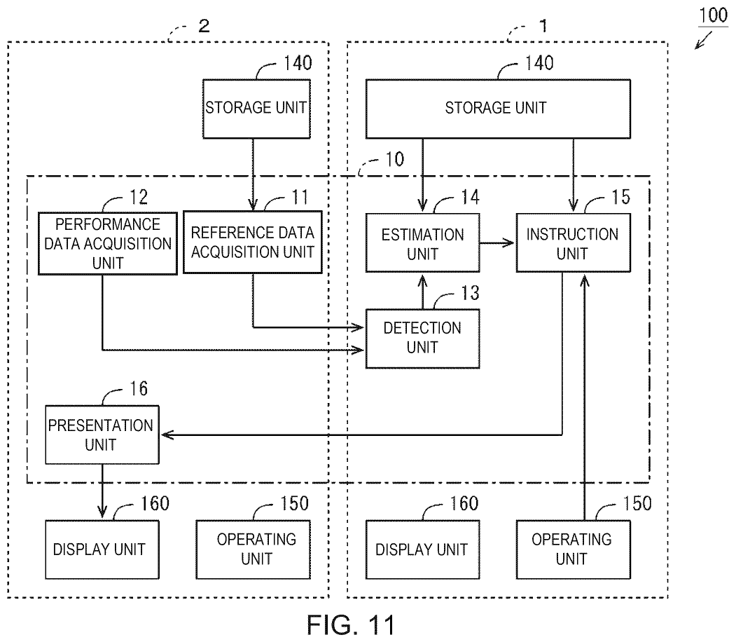

FIG. 10 is a block diagram showing a configuration of the teaching device 10 according to a second modified example. As shown in FIG. 10, the teaching device 10 according to the present example further comprises a holding unit 18 as a functional unit. The holding unit 18 can be realized by the CPU 130 of FIG. 1 executing a teaching program on the RAM 110, or realized in hardware such as an electronic circuit. In addition, the holding unit 18 can be provided in the teaching device 10 according to the first modified example of FIG. 9.

The holding unit 18 holds the instruction content item presented by the presentation unit 16. The instruction content item held by the holding unit 18 is updated each time performance data of the same performance piece are acquired by the performance data acquisition unit 12. When an instruction content item is determined for a performance error in any given performance data acquired by the performance data acquisition unit 12, the instruction unit 15 determines an instruction content item that is different from the instruction content item held by the holding unit 18 for a performance error in the subsequently acquired performance data.

Therefore, in the teaching process of the present example, a process is added after step S8, the process being one in which the holding unit 18 holds the instruction content item presented in step S8. Thereafter, the process returns to step S3. If new practice data are input to the teaching device 10 in step S3, an instruction content item that is different from the previously determined instruction content item is determined in the subsequent step S7. In addition, the instruction content item that is held is updated in step S8.

In this manner, in the teaching device 10 according to the present example, an instruction content item that is presented once will not be presented again in succession. Therefore, it is possible to easily prevent only a single instruction content item being determined even when the user makes a performance error due to multiple reasons. As a result, it is possible to provide more practical teaching of performance.

FIG. 11 is a block diagram showing a configuration of the teaching device 10 according to a third modified example. As shown in FIG. 11, the teaching system 100 according to the present example is composed of a server computer 1 and a client computer 2. The server computer 1 is provided so as to be accessible by a large number of users. The client computer 2 can be a smart device owned by a user, for example. Accordingly, the teaching system 100 can be composed of a common server computer 1 and a plurality of client computers 2.

Each of the server computer 1 and the client computers 2 includes the RAM 110, the ROM 120, the CPU 130, the storage unit 140, the operating unit 150, and the display unit 160 of FIG. 1. In addition, of the functional units of the teaching device 10, the detection unit 13, the estimation unit 14, and the instruction unit 15 are provided in the server computer 1, and the reference data acquisition unit 11, the performance data acquisition unit 12, and the presentation unit 16 are provided in the client computer 2. The selection unit 17 in the first modified example of FIG. 9 and the holding unit 18 in the second modified example of FIG. 10 can also be provided in the client computer 2.

In the teaching device 10 according to the present example, each user inputs performance data into the user's own client computer 2, and the server computer 1 determines the instruction content item for the performance data. In addition, the instruction content item that has been determined is displayed on the display unit 160 of the corresponding client computer 2. In this manner, each user can more easily utilize the teaching device 10.
(a) In the embodiment described above, the reference data acquisition unit 11 acquires musical score data as the reference data, but the embodiment is not limited thereto. The reference data acquisition unit 11 can generate reference data indicating a time series of reference sounds of a practice piece on the basis of performance data that have been acquired a plurality of times by the user.
(b) In the embodiment described above, the estimation unit 14 estimates the causes of performance errors on the basis of the correspondence information, but the embodiment is not limited thereto. The causes of performance errors can be estimated on the basis of a leaning model that has learned the relationship of performance data, the types and frequency of errors and the causes of errors.

Similarly, the instruction unit 15 determines the instruction content item on the basis of the instruction information, but the embodiment is not limited thereto. The instruction unit 15 can determine the instruction content item on the basis of a learning model that has learned the relationship of the frequency and causes of errors and the instruction content items.
(c) In the embodiment described above, the teaching device 10 includes the presentation unit 16, but the embodiment is not limited thereto. As long as the user can utilize the instruction content item determined by the instruction unit 15, the teaching device 10 does not need to include the presentation unit 16.

What is claimed is:

1. A teaching device comprising:
a controller including memory storing instructions and at least one processor that implements the instructions, the instructions comprising
acquiring reference data indicating a time series of reference sounds,
acquiring performance data indicating a time series of sounds expressed by a user's performance,
detecting a performance error by comparing the reference data and the performance data,
estimating a cause of the error based on performance history, and
determining an instruction content item based on frequency of the error and the cause.

2. The teaching device according to claim 1, further comprising
presenting the determined instruction content item.

3. The teaching device according to claim 2, further comprising
selecting the instruction content item to be presented based on the frequency of the error or importance of the error.

4. The teaching device according to claim 2, further comprising
holding the presented instruction content item, wherein
the determining of the instruction content item includes determining an instruction content item that is different from the held instruction content item in subsequent practice.

5. The teaching device according to claim 1, wherein
the estimating of the cause of the error includes estimating the cause of the error based on a frequency of the error and a table in which types of errors are associated with causes.

6. A teaching method executed by at least one processor of a computer, the method comprising:
acquiring reference data indicating a time series of reference sounds;
acquiring performance data indicating a time series of sounds expressed by a user's performance;
detecting a performance error by comparing the reference data and the performance data;
estimating a cause of the error based on performance history; and
determining an instruction content item on the basis of frequency of the error and the cause.

7. The teaching method according to claim 6, further comprising
presenting the determined instruction content item.

8. The teaching method according to claim 7, further comprising
selecting the instruction content item to be presented based on the frequency of the error or importance of the error.

9. The teaching method according to claim 7, further comprising
holding the presented instruction content item, wherein
the determining of the instruction content item includes determining an instruction content item that is different from the held instruction content item in subsequent practice.

10. The teaching method according to claim 6, wherein
the estimating of the cause of the error includes estimating the cause of the error based on a frequency of the error and a table in which types of errors are associated with causes.

11. A non-transitory computer-readable storage medium storing a program executable by at least one processor of a computer system to perform a teaching method, the teaching method comprising
acquiring reference data indicating a time series of reference sounds,
acquiring performance data indicating a time series of sounds expressed by a user's performance,
detecting a performance error by comparing the reference data and the performance data,
estimating a cause of the error based on performance history, and
determining an instruction content item based on frequency of the error and the cause.

12. The non-transitory computer-readable storage medium according to claim 11, further comprising
presenting the determined instruction content item.

13. The non-transitory computer-readable storage medium according to claim 12, further comprising
selecting the instruction content item to be presented based on the frequency of the error or importance of the error.

14. The non-transitory computer-readable storage medium according to claim 12, further comprising
holding the presented instruction content item, wherein
the determining of the instruction content item includes determining an instruction content item that is different from the held instruction content item in subsequent practice.

15. The non-transitory computer-readable storage medium according to claim 11, wherein
the estimating of the cause of the error includes estimating the cause of the error based on a frequency of the error and a table in which types of errors are associated with causes.
